(19) United States
(12) Patent Application Publication
(10) Pub. No.: US 2015/0131314 A1
(43) Pub. Date: May 14, 2015

(54) SIDE-LIGHT TYPE BACKLIGHT MODULE

(71) Applicant: HON HAI PRECISION INDUSTRY CO., LTD., New Taipei (TW)

(72) Inventor: SHAO-HAN CHANG, New Taipei (TW)

(21) Appl. No.: 14/508,812

(22) Filed: Oct. 7, 2014

(30) Foreign Application Priority Data
Nov. 11, 2013 (CN) 2013105560306

(51) Int. Cl. F21V 8/00

(52) U.S. Cl. CPC G02B 6/0091; G02B 6/0073; G02B 6/0051; G02B 6/0053
USPC 362/607; 362/606

(57) ABSTRACT

A side-light type backlight module includes an optical film, a front frame, a reflective plate, a back cover, and a light source panel. The front frame includes a step-shaped receiving portion configured to receive the optical film. The light source panel is positioned at one side of the back cover. The reflective plate and the front frame are received in the back cover. A plurality of through holes is defined in the reflective plate. The reflective plate and the back cover cooperatively define a chamber.

### FIELD

The subject matter herein generally relates to the field of backlight modules, and in particular to a side-light type backlight module.

### BACKGROUND

A liquid crystal display apparatus (LCD apparatus) has been applied in cell phones, laptops, personal computers (PC), personal digital assistants (PDA), and other consumer electronic products. Since the LCD panel of an LCD apparatus itself does not emit, a backlight module is required to provide the LCD panel with a required light source.

Known backlight modules can be divided into a direct-light type and a side-light type according to the location of the light source. A conventional side-light type backlight module includes a bezel, a frame, a light source, a light guide plate, a diffusion plate, and a plurality of optical films. The optical films are positioned above the diffusion plate.

### BRIEF DESCRIPTION OF THE DRAWINGS

Implementations of the present technology will now be described, by way of example only, with reference to the attached figures.

FIG. 1 is an exploded, perspective view of a first embodiment of a side-light type backlight module.

FIG. 2 is a cross-sectional view of the side-light type backlight module of FIG. 1.

FIG. 3 is a diagrammatic view illustrating light paths of the side-light type backlight module of FIG. 1.

FIG. 4 is a cross-sectional view of a second embodiment of a side-light type backlight module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising”, when utilized, means “including, but not necessarily limited to”; it specifically indicates open-ended inclusion or membership in the so-described combination, group, series and the like.

The present disclosure is described in relation to a side-light type backlight module.

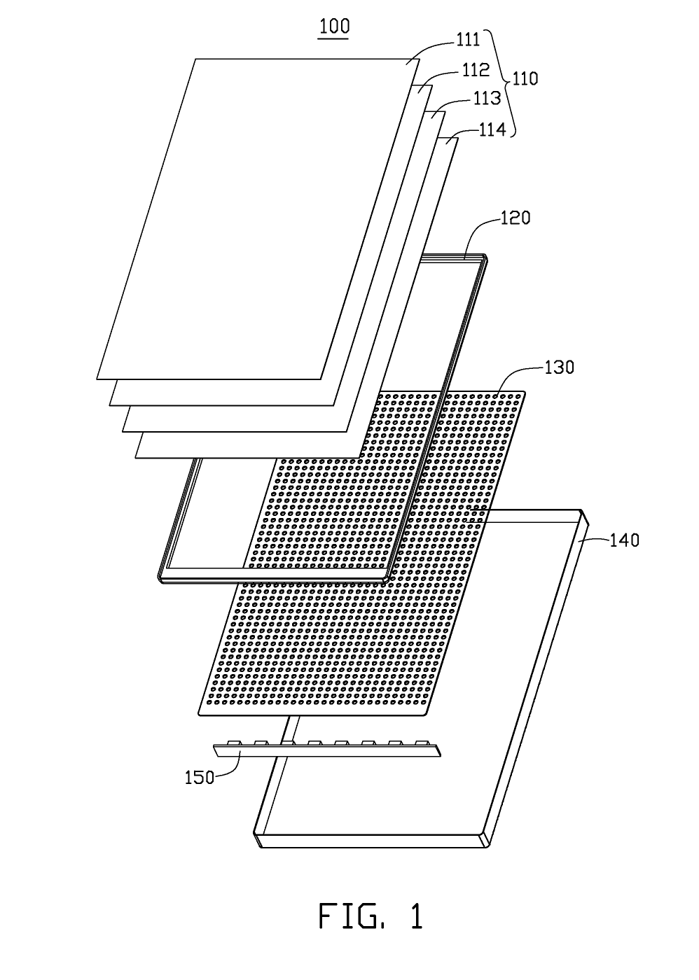

FIG. 1 illustrates an embodiment of a side-light type backlight module 100. The side-light type backlight module 100 can include an optical film 110, a front frame 120, a reflective plate 130, a back cover 140, and a light source panel 150. The optical film 110 can be assembled to the front frame 120, and the back cover 140 is assembled to the front frame 120. The reflective plate 130 and the light source panel 150 can be received in the back cover 140, and the light source panel 150 can be positioned at one side wall of the back cover 140.

The optical film 110 can include a plurality of complementary optical elements. In the illustrated embodiment, the optical film 110 can include a first diffusion sheet 111, a first prism lens 112, a second prism lens 113, and a second diffusion sheet 114 arranged on top of each other in that order toward the front frame 120.

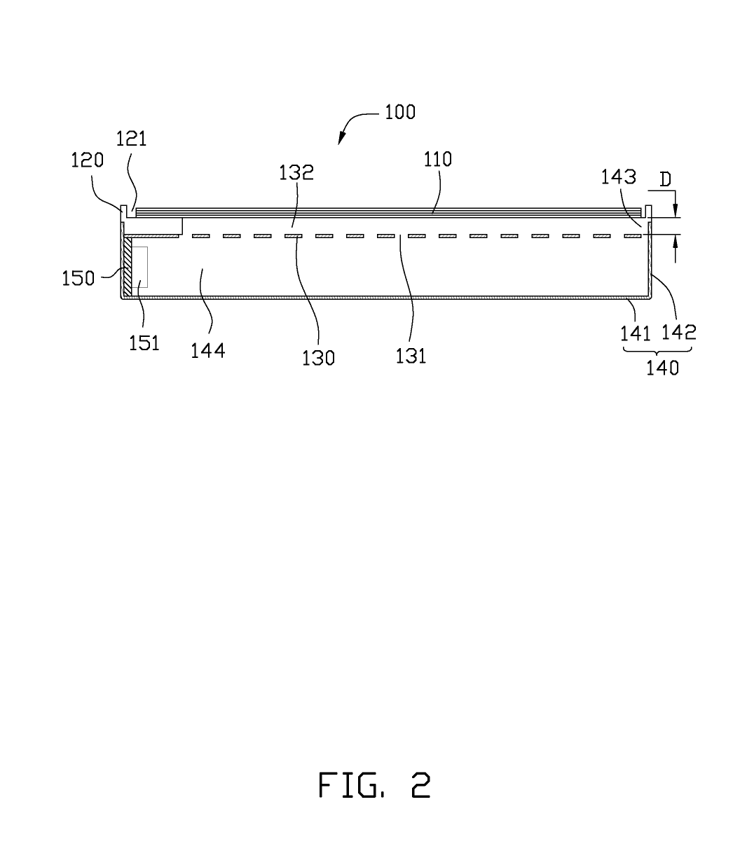

Referring to FIG. 2, the front frame 120 can be a substantially rectangular frame and can be made of a metal. In other embodiments, the front frame 120 can be made of a plastic or other materials. The front frame 120 can define a receiving portion 121 configured to receive the optical film 110. In one embodiment, the receiving portion 121 can be step-shaped. In other embodiments, the receiving portion 121 can be other shapes.

The reflective plate 130 can be substantially rectangular. The reflective plate 130 can be received in the back cover 140. The reflective plate 130 can be made of a metal. The reflective plate 130 can define a plurality of through holes 131. The plurality of through holes 131 are distributed evenly and configured to change an angle of light incident to the reflective plate 130 into a transmitting light with high density. Each of the through holes 131 can be circular, rectangular, or other shapes. Two opposite surfaces (not labeled) of the reflective plate 130 can be attached with a high reflection film.

As the optical film 110 is received in the receiving portion 121 of the front frame 120, a light mixing space 132 can be defined between the optical film 110 and the reflective plate 130. A distance between the optical film 110 and the reflective plate 130 can be defined as D, and the distance D can be pre-determined according to actual requirements. To make a luminance of the light emitted from the backlight module 100 uniform, the distance D can be equal to or larger than 0.2 millimeter (mm).

The back cover 140 can be made of a metal by molding. The back cover 140 can be box-shaped and include a back plate 141 and a plurality of side plates 142. The back plate 141 and the plurality of side plates 142 can cooperatively define an opening 143, and a size of the opening 143 can match a size of the front frame 120 and the reflective plate 130. The back cover 140 can be assembled to the front frame 120. Inner surfaces of both the back plate 141 and the plurality of side plates 142 can be covered by a layer having a reflectivity of about 0.9 or greater. The high reflectivity layer can be made of silver or other materials, such as printed ink.

The light source panel 150 includes at least one light source 151. The light sources 151 can be a light emitting diode (LED).

The back cover 140 and the reflective plate 130 cooperatively define a chamber 144, and an inner surface of the chamber 144 can be highly reflective. The light emitted from the light sources 151 can be mixed in the chamber 144 by being reflected by the inner surfaces of the back cover 140 and the reflective plate 130, and transmitted out of the reflective plate 130 by passing through the through holes 131. The chamber 144 can replace a conventional light guide plate. Moreover, the chamber 144 can be smaller and thinner than a conventional light guide plate.

In assembly, the light source panel 150 can be attached to the side plate of the back cover 140, and the reflective plate 130 and the front frame 120 can be received in the opening 143. The first diffusion sheet 111, the first prism lens 112, the second prism lens 113, and the second diffusion sheet 114 can be stacked together in order toward the front frame 120 and the optical film 110 can be received in the receiving portion 121 of the front frame 120.

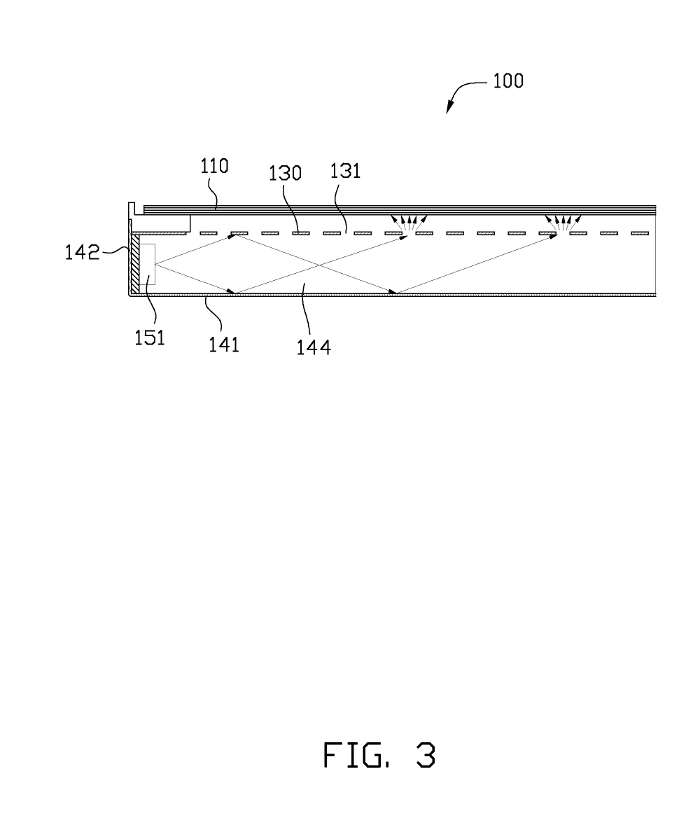

FIG. 3 illustrates a diagrammatic view of light paths of the side-light type backlight module 100. In use, the light sources 151 can emit light, and the light can be transmitted into the chamber 144. A portion of the light can be transmitted through the through holes 131 directly, and another portion of the light can be reflected in the chamber 144 multiple times before being transmitted through the plurality of through holes 131. The light transmitted through the plurality of through holes 131 can be small beams of light with high density. Then, the light can be mixed between the reflective plate 130 and the optical film 110. Thus, the light incident to the optical film 110 can be uniform.

The light guide plate of the conventional backlight module can be replaced with the chamber 144, thereby making the side-light type backlight module 100 lighter. The present disclosure can realize both the luminance uniformity of backlight module 100 and a thin design of a liquid crystal display device.

Because the reflective plate 130 and the back cover 140 can be made of a metal, the reflective plate 130 and the back cover 140 can dissipate heat generated by the light sources 151.

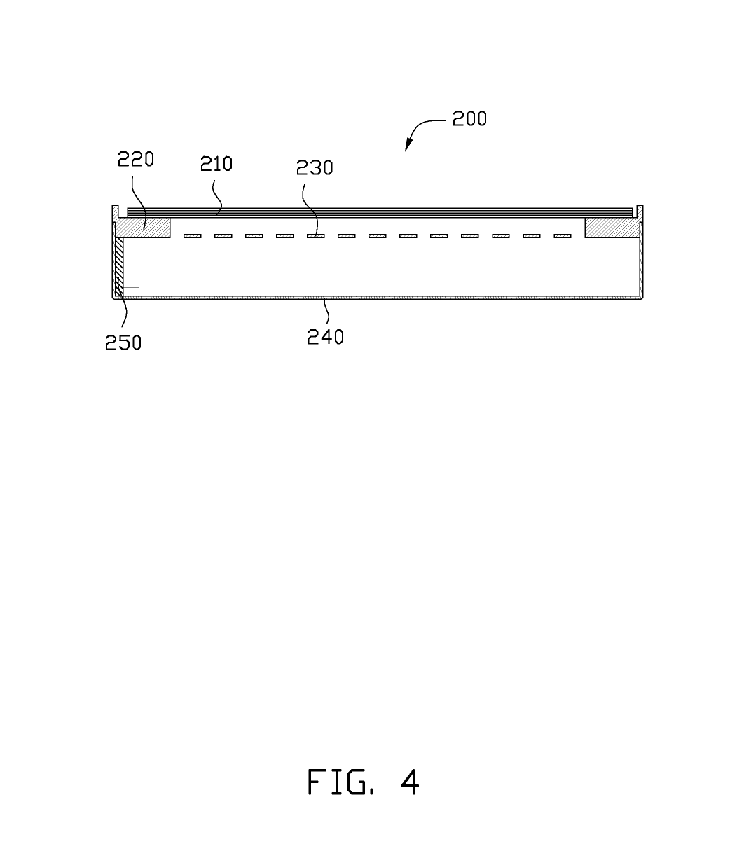

FIG. 4 illustrates a second embodiment of a side-light type backlight module 200. The side-light type backlight module 200 can include an optical film 210, a front frame 220, a reflective plate 230, a back cover 240, and a light source panel 250. The optical film 210 can be located on the front frame 220. The back cover 240 is placed under the front frame 220 and located opposite to the optical film 210. The reflective plate 230 can be located between the front frame 220 and the back cover 240. The light source panel 250 can be located in the back cover 240 and positioned at one side wall of the back cover 240. The front frame 220, the reflective plate 230, and the back cover 240 can be made of a plastic. The front frame 220 can be integrated with the reflective plate 230.

As the front frame 220, the reflective plate 230, and the back cover 240 can be made of a plastic, the side-light type backlight module 200 can be light. Further, the front frame 220 and the back cover 240 can be an integrated housing, thereby simplifying a structure of the side-light type backlight module 200. The side-light type backlight module 200 can also realize both the luminance uniformity and thin design of a liquid crystal display device.

In other embodiments, a side-light type backlight module can include a front frame made of a plastic, and a reflective plate and back cover made of a metal. The reflective plate and the back cover can be an integrated housing formed by insert molding.

As the reflective plate and the back cover of the side-light type backlight module can be an integrated housing formed by insert molding, the side-light type backlight module can have a simple structure. The side-light type backlight module can also realize both the luminance uniformity and thin design of a liquid crystal display device.

The embodiments shown and described above are only examples. Many details are often found in the art such as the other features of a side-light type backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A side light type backlight module comprising:
a back cover attached to the front frame, the back cover having a back plate and a plurality of side plates extending substantially perpendicular up from the back plate;
a reflective plate attached to the back cover, the reflective plate cooperating with the back cover to form a back cover chamber;
a light source positioned on one of the plurality of side plates within the back cover cavity;
a front frame attached to the side plates; and
optical film attached to the front frame;
wherein, inner surfaces of the back cover chamber have substantially high reflectivity; and
wherein, the reflective plate is positioned between the back plate and the optical film and includes a plurality through holes configured for changing light incident to the reflective plate to higher density transmitted light.

2. The side-light type backlight module as claimed in claim 1, wherein the optical film and the reflective plate cooperatively define a light mixing space, a distance between the optical film and the reflective plate is equal to or larger than 0.2 mm.

3. The side-light type backlight module as claimed in claim 1, wherein each of the plurality of through holes are circular or rectangular.

4. The side-light type backlight module as claimed in claim 1, wherein the front frame, the back cover and the reflective plate are made of a metal.

5. The side-light type backlight module as claimed in claim 1, wherein the front frame, the back cover and the reflective plate are made of a plastic, the front frame is integrated with the reflective plate.

6. The side-light type backlight module as claimed in claim 1, wherein the front frame is made of a plastic, the back cover and the reflective plate are made of a metal, and the reflective plate and the back cover are integrated housing formed by insert molding.

7. The side-light type backlight module as claimed in claim 1, wherein inner surfaces of both the back plate and the plurality of side plates are covered by a layer having a reflectivity of about 0.9 or greater.

8. The side-light type backlight module as claimed in claim 7, wherein the back plate and the plurality of side plates cooperatively define an opening, and a size of the opening match a size of the front frame and the reflective plate.

9. The side-light type backlight module as claimed in claim 1, wherein the receiving portion is step-shaped.

10. The side-light type backlight module as claimed in claim 1, wherein the light source panel comprises at least one light source, the light sources are light emitting diodes.

11. The side-light type backlight module as claimed in claim 1, wherein the optical film comprises a first diffusion sheet, a first prism lens, a second prism lens, and a second diffusion sheet arranged on top of each other in that order forward the front frame.
